(19) United States
(12) Patent Application Publication
(10) Pub. No.: US 2022/0163314 A1
(43) Pub. Date: May 26, 2022

(54) A GROUND MOVEMENT MONITORING SYSTEM AND METHOD

(71) Applicant: Osprey Measurement Systems LTD, London (GB)

(72) Inventors: Daniel Scott, Uckfield, East Sussex (GB); Peter Scott, Austinmer, New South Wales (AU)

(21) Appl. No.: 17/598,397

(22) PCT Filed: Mar. 27, 2020
(86) PCT No.: PCT/EP2020/058835

§ 371 Date: Sep. 27, 2021

(30) Foreign Application Priority Data
Mar. 28, 2019 (GB) 1904346.2

(51) Int. Cl. G01B 7/02

(52) U.S. Cl. CPC G01B 7/023; G01B 7/24

(57) ABSTRACT

A ground movement monitoring system comprising a rigid support (304), a magnetically sensitive probe (200) and a magnet (100), wherein the probe (200) is capable of detecting a displacement of the magnet (100), wherein in use the magnet (100) is configured to be fixed in the ground (320, 330, 340), the support (304) is configured to be located in the ground (320, 330, 340), an end of the support (304) being fixed in position relative to the ground (320, 330, 340), and the probe (200) is configured to be attached to the support (304) proximally to the magnet (100), wherein the displacement of the magnet (100) as detected by the probe (200) is communicated to a surface system (308), the surface system (308) being configured to record any displacement of the magnet (100).

### TECHNICAL FIELD

The present disclosure relates to a ground movement monitoring system and method, and is particularly, although not exclusively, related to an automatic ground movement monitoring system for a borehole.

### BACKGROUND

A large proportion of construction takes place on soils, which are known to deform in response to applied loads. In order to prevent soil deformation occurring during or after construction, it is known to place additional material on top of the soil at the construction site prior to construction, such that the soil becomes normally consolidated. This process is known as ‘surcharging’. Deformation is also known to occur during the construction of cuttings and tunnels.

It is important to measure the behaviour of the soil before, during and after construction. As such, extensometers exist which measure the behaviour of the soil surrounding a borehole.

Given that these sites are often at remote and dangerous locations, it is undesirable for an operator to need to visit each borehole site to take readings manually. Additionally, manual readings are costly and produce temporally sparse data.

Accordingly, it is desirable that readings be made automatically without the involvement of an operator.

### STATEMENTS OF INVENTION

According to an aspect of the present disclosure, there is provided a ground movement monitoring system comprising a rigid support, a magnetically sensitive probe and a magnet. The probe is capable of detecting a displacement of the magnet. In use, the magnet is configured to be fixed in the ground, the support is configured to be located in the ground, an end of the support being fixed in position relative to the ground, and the probe is configured to be attached to the support proximally to the magnet, wherein the displacement of the magnet as detected by the probe is communicated to a surface system, the surface system being configured to record any displacement of the magnet.

The support may be located in an access tube, the probe thereby being isolated from movement of soil surrounding the tube. The access tube may comprise non-grooved access casing.

The system may additionally comprise at least one other magnetically sensitive probe and at least one other magnet. The probes may be connected in series to the surface system by means of a single cable digital bus. The system may be configured to be located within a borehole. The rigid support may be fixed vertically in the ground within the access tube. The rigid support may be bottom-supported.

The at least one probe may be rotationally invariant. The at least one magnet may be a ring magnet. The at least one ring magnet may be configured in use to be located peripherally to a borehole. The probes may attach to the support by means of a horseshoe-shaped receiving portion. The probes may attach laterally to the support by means of a recess. The probes may be located centrally within the borehole with respect to a vertical axis of the borehole. Each probe may be attached to the support by means of a clearance fit between the recess and support. At least one releasable fixing, such as a grub screw, may also be used to releasably attach each probe to the support.

The system may be configured to determine displacements of the magnets. The system may be configured to communicate the displacement of the ring magnets to a location remote from the system. The system may be automated.

According to a second aspect of the present invention, there is provided a method of preparing a site for construction. The method may comprise surcharging the site with additional material. The above-mentioned ground movement monitoring system may be installed. The surface system may be configured to determine the displacement of each magnet. The additional material may be removed when it is determined that the site is normally consolidated.

According to another aspect of the present disclosure there is provided a ground movement monitoring system comprising a support, a plurality of magnetically sensitive probes and a plurality of magnets, wherein each probe of the plurality of probes may be capable of detecting a displacement of a corresponding magnet of the plurality of magnets. The support may be rigid, or alternatively the support may not be rigid. For example, it may comprise a rope, string, pipe or chord. In use, the plurality of magnets may be configured to be fixed in the ground, the support may be configured to be located in the ground, and the plurality of probes may be configured to be attached to the support proximally to the magnets, wherein the displacement of each magnet of the plurality of magnets may be detectable by at least one probe of the plurality of probes. The support may be suspended from the surface into the borehole. The displacement of each magnet as detected by the at least one probe may be communicated to a surface system. The surface system may be configured to record any displacement of each magnet of the plurality of magnets.

According to another aspect of the present invention, there is provided a method for monitoring ground movement, wherein the method comprises installing a ground movement monitoring system configured to determine the displacement of each magnet of a plurality of magnets. The probes may be installed within the borehole at depths aligning with the plurality of magnets. The method may not require the movement of the probes within the borehole in order to detect the location of the magnets. The probes may be stationary within the borehole. The probes may not be required to be moved in order that the system may be able to determine the location of each magnet. The method may comprise occasional determination of the height of the support with respect to a stable site datum. The support may need to be periodically adjusted in height according to the consolidation of the soil such that it does not protrude excessively above the soil surface.

The surface system may be configured to determine the displacement of each magnet. The probes may be configured to calculate the displacement of each magnet.

There may be a greater number of probes than magnets.

To avoid unnecessary duplication of effort and repetition of text in the specification, certain features are described in relation to only one or several aspects or embodiments of the invention. However, it is to be understood that, where it is technically possible, features described in relation to any aspect or embodiment of the invention may also be used with any other aspect or embodiment of the invention.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is a schematic representation of a ring magnet;

FIG. 2 is a schematic representation of a probe;

FIG. 3 is a schematic representation of the present invention having been installed in a borehole; and

FIG. 4 is a schematic representation of a transverse cross section through the borehole of FIG. 3 which comprises the present invention.

### DETAILED DESCRIPTION

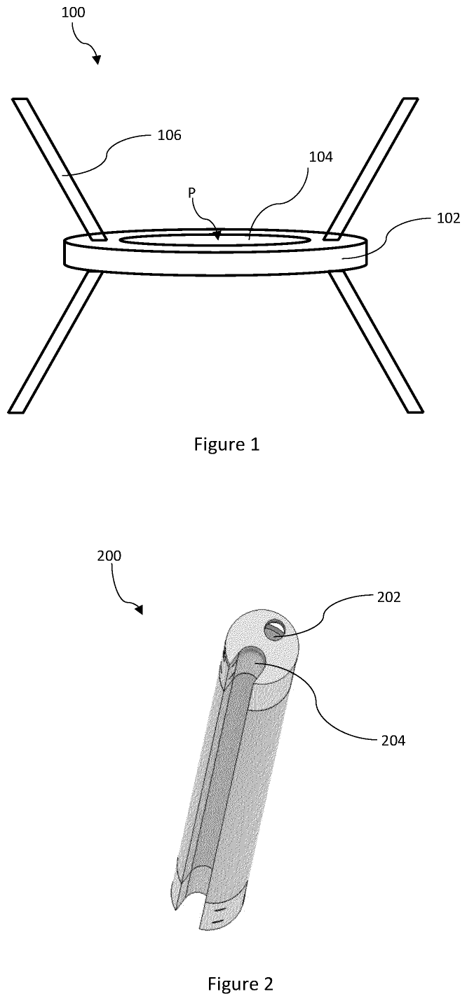

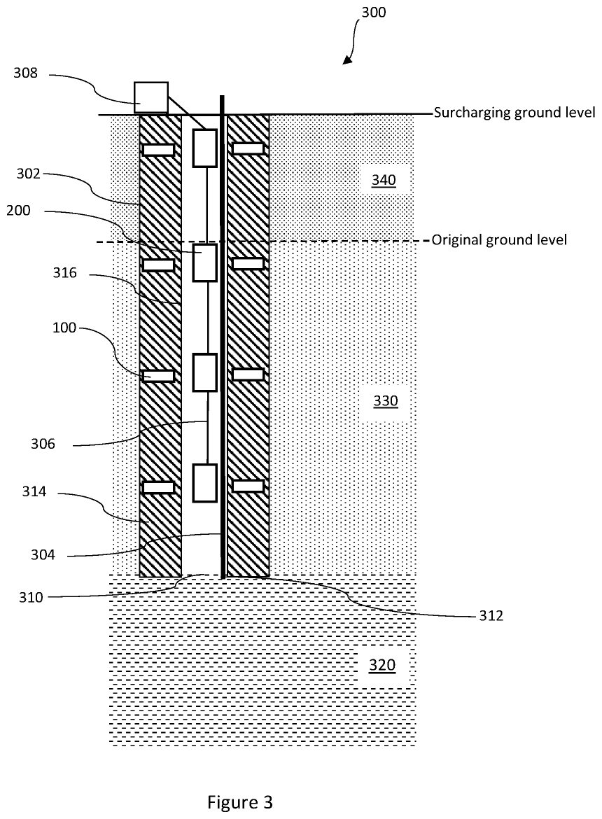

FIG. 1 shows a ring magnet 100. The ring magnet 100 comprises an annular body 102, a central opening 104 and a number of projections 106. The annular body 102 of the ring magnet 100 may be made of any suitable material, such as a hard ferromagnetic material known by the skilled person, or engineering plastics with magnetic material embedded in it. The magnetic field produced by the magnet 100 will be strongest at a fixed and substantially stable position P relative to the central opening 104. The projections 106 help the magnet 100 to anchor itself within the material into which it is placed, such as soil 330, 340 (FIG. 3). The projections 106 may be biased away from the annular body 102 of each ring magnet 100, for example by forming the projections 106 from elastically deformable material or by connecting each projection 106 to the annular body 102 by means of a hinge and using a resilient element to bias each projection 106 away from the annular body 102. The central opening 104 may have dimensions sufficient to allow the passage of an access tube 316 (FIG. 3), for example of circular cross section.

FIG. 2 shows a probe 200 which is suitable for use in the present invention. The probe 200 comprises a port 202 into which a communication cable, for example a single cable digital bus 306 (FIG. 3), can be inserted for connection to the probe 200.

The probe 200 additionally comprises a means of attaching to a support, such as a rigid support 304, in the form of a recess 204. The recess 204 has a cross section which substantially conforms to the support 304. In FIG. 2, the recess 204 is not enclosed and forms an incomplete boundary, such that the probe 200 has a substantially horseshoe-shaped transverse cross section. The probe 200 may therefore be attachable to the rigid support 304 at any point along the length of the rigid support 304 by means of lateral attachment, i.e. the probe is attachable in a direction perpendicular to the axis of the support 304, such that the probe 200 may be attached to the support 304 along its side by means of recess 204. This means of attachment may be termed ‘side-loading’. Upon attachment to the support 304, both the probe 200 and the support 304 may be parallel and contiguous. Similarly, the probe 200 may be detachable in a direction perpendicular to, and away from, the axis of the support 304. Alternatively, the recess 204 may have any cross section, and may be such that lateral attachment is not possible, for example an enclosed recess extending through the length of the probe 200 such that it must be inserted or threaded onto the support from one end.

The probe 200 may be attached to the support 304 by inserting the support 304 into the recess 204. The probe 200 may be attached to the support 304 by any suitable type of fit, such as an interference, clearance or transition fit. This fit may be combined with releasable fixings, for example, screws or bolts, to secure the probe 200 in position on the support 304. In one example, the recess 204 may be attachable to the support 304 by means of a clearance fit, and one or more grub screws may be used to secure the probe 200 in position on the support 304. The present means of attachment is superior to prior arrangements, which may use other means such as cable tying or taping in order to attach a probe to a support. The present means of attachment offers greater rigidity and/or security, especially in ensuring that a probe 200 does not gradually slide down a support 304 during its use as part of a ground movement monitoring system.

The external dimensions of the probe 200 may be smaller than the internal dimensions of the central opening 104 of the magnet 100 such that the probe may be able be located within the central opening 104.

The probe 200 is magnetically sensitive, and is able to detect a magnetic field resulting from the magnet 100, the magnetic field having penetrated a small thickness of material, for example a plastic access tube 316 and filler material, e.g. bentonite grout, of thickness similar to the radius of a borehole 302.

The probe 200 may comprise a number of sensors, such as Hall effect sensors, which, in combination, may be capable of determining the location of a magnet in at least one dimension. The sensors within the probe 200 may be spaced apart at by a set distance, for example 10 mm. Probes 200 of this sort will be known to the skilled person.

The probe 200 may be rotationally invariant with respect to its magnetic sensitivity, i.e. it may be able to equally detect magnetic fields from any direction within the same plane, or, in other words, the exact rotational orientation of the probe within the borehole with respect to a vertical axis may not be of importance when detecting the magnetic field from a ring magnet 100.

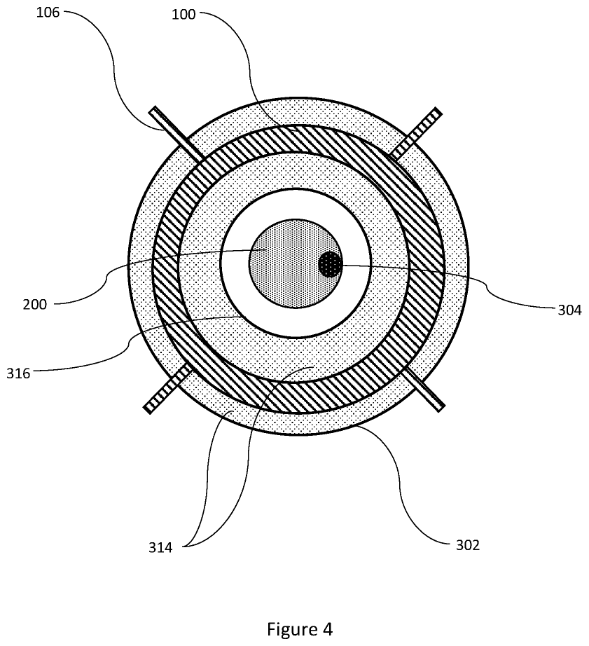

With reference to FIGS. 3 and 4, the present invention is described having been installed at a construction site 300. The construction site 300 shown in FIG. 3 is undergoing surcharging, in which additional material 340 has been deposited on top of the pre-existing soil 330 at the original ground level, to form a new level called the surcharging ground level. The soil 330, located upon a stable stratum 320 such as rock, is now in a state of under-consolidation.

A borehole 302 has been drilled at the construction site 300, which passes downwards through the additional material 340 and the soil 330. The borehole 302 may finish such that its lowermost end 310 is in contact with the stable stratum 320. In the example of FIG. 3, the borehole is substantially vertical, however the present system may equally be installed in non-vertical, including non-linear, boreholes, which may have one or more curves or bends. The borehole 302 may have previously existed at the construction site 300 for reasons other than the installation of the present invention. Alternatively the borehole 302 may have been drilled for the purpose of ground movement monitoring using the present invention, or may be the result of extension where the existing ground level is raised through the addition of further soil or other surcharge or fill material.

Within the borehole 302 is located an access tube 316. The access tube 316 may have any suitable cross section, however a circular cross section is most typical. The access tube 316 may have an end-cap (not shown) which sits at the lowermost end 310 of the borehole 302. It is noted that the access tube 316 does not require grooves or ridges running along its length. In this way, standard plastic tubing or piping, for example with a diameter of one inch, may be used.

Within the access tube 316 is a support 304. The support 304 is any means suitable for holding each of the probes 200 in a fixed position. In FIG. 3, the support 304 is rigid, such as a rod, and engages the stable stratum 320 at its base 312, for example directly or by means of a bottom cap of the access tube 316, in a position which is off-centre of the access tube 316. This off-centred configuration is to allow laterally attached probes 200 of the type shown in FIG. 2 to be centred within the access tube 316 and borehole 302. The rigid support 304 in this arrangement is said to be bottom-supported. The rigid support 304 may provide a useful datum for measurement.

A number of ring magnets 100 have been installed in the annular space 314 between the access tube 316 and the outer wall of the borehole 302. The ring magnets 100 are embedded in the surrounding material 340 and soil 330 in the immediate vicinity of the borehole 302 by means of the projections 106. As such, the projections 106 extend beyond and engage in the walls of the borehole 302. The annular space 314 is filled with a filler material, such as bentonite grout, which prevents uncontrolled collapse of the borehole 302, whilst allowing the magnets 100 to freely move with the surrounding material 340 and soil 330. Thus the filler material is intended to match the dimensional behaviour of the surrounding ground and transfer this onto the ring magnet 100 that it encases.

The ring magnets 100 have central openings 104 of inner diameter greater than the outer diameter of the access tube 316, such that the ring magnets 100 are located concentrically and peripherally to the access tube 316. The ring magnets 100 have sufficiently strong magnetic fields and are located sufficiently proximal to the probes 200 that the magnetic field of each ring magnet 100 penetrates any surrounding soil 330, 340 (not shown to separate the ring magnet 100 from the access tube 316 in either of FIG. 3 or 4), the filler material in the annular space 314 and the access tube 316, such that the magnetic field of each ring magnet 100 is detectable by a magnetically sensitive probe 200 and/or a corresponding magnetically sensitive probe 200. The magnetic field of each ring magnet 100 may be detectable by at least one magnetically sensitive probe 200.

The probes 200 are rigidly fixed to the support 304 by means of their recesses 204 at a number of locations along the length of the support 304. The probes 200 may be spaced apart by a fixed interval, or alternatively may be spaced so as to align with the ring magnets 100. The probe 200 may be significantly longer than the maximum displacement of the soil 330 and/or additional material 340, including the ring magnet 100, envisaged by the installer, such that the location of the probe need not be adjusted during the process of soil deformation.

The probes 200, access tube 316 and ring magnets 100 are located concentrically with respect to a vertical, central axis of the borehole 302. In other configurations, perfect concentricity of these components may not be necessary.

Other means of supporting the probes 200 exist, such as top-supporting, where either a rigid rod or a wire can be fixed at the top of the borehole 302, and the probes 200 are suspended in the borehole 302 by means of the top-supported rod or wire. As the soil 330, 340 consolidates, the position of the top of the top support may be measured with respect to another stable site datum. A wire support, for example, may not be compatible with the recess 204 of the probe 200 of FIG. 2. Instead, each probe 200 might have to be fed onto a wire support by means of an enclosed through-length recess (not shown).

As will be understood by the skilled person, other magnet and probe arrangements are applicable. For example, the ring magnets 100 may instead be magnets of any shape, and may not necessarily be located circumferentially to the borehole 302. The magnets 100 should be placed within the soil 330, 340 in sufficient proximity to probes 200 that their magnetic field is still detectable. Additionally, there may be different numbers of probes 200 and magnets 100. In the example of FIG. 3, there are equal numbers of probes 200 and ring magnets 100, the depth of each probe 200 aligning with that of a corresponding ring magnet 100. However, there may alternatively be more probes 200 than ring magnets 100, the magnetic field of each magnet 100 thus being detectable by at least one probe 200. Additionally or alternatively, each magnet 100 may have at least one corresponding probe 200.

The probes 200 may be joined in series by means of a single cable digital bus 306, which connects to a surface system 308, such as a data logging device. The surface system 308 may be any device configured to record the measured displacement of each ring magnet 100. The surface system 308 may be any device configured to send a ‘read’ command over the single cable digital bus 306, and record the return from the probes 200. The read command may be automatically triggered by a timer, corresponding to a given frequency that may be determined upon setup of the system, an event, such as a sensor triggering an alert to prompt a reading, or a command from a user, the user being either local or remote. The results of the read command may be stored on local memory, or alternatively communicated to a location remote from the construction site 300, by means of a radio or cabled network connection.

The single cable digital bus 306 is not shown in FIG. 4.

In use, the probes 200 and magnets 100 are calibrated with one another and with the rigid support 304 such that an initial condition is determined. This initial condition may relate to the depth of each ring magnet 100 and/or the location of each probe 200. Additionally or alternatively, this initial condition may relate to the separation between ring magnets 100, the separation between probes 200 and/or the magnetic field detected by each probe 200. This initial condition may also relate to determinations of the location of each ring magnet in greater than one dimension, for example dimensions in a horizontal plane, such that lateral displacements may also be determined.

As the soil 330 and/or material 340 of the construction site 330 deform, any ring magnets 100 which are embedded within the deforming soil 330 and/or material 340, along with the magnetic fields of the magnets 100, become displaced. As such, as the soil 330 and/or material 340 deform, the probes 200 proximal to any displaced ring magnets 100 will detect different magnetic fields from those of the initial conditions.

Calculations, known in the art, can be performed such that the displacement and/or new location of each ring magnet 100 can be determined, along with the deformation behaviour of the soil 330 and/or material 340. For example, these calculations may comprise an algorithm which works out a centroid of the magnetic field of each magnet 100 based on the detected magnetic field. These calculations may be performed by the surface system 308, and the calculated displacement of each ring magnet 100 may be communicated to a remote location or stored by the surface system 308 for future retrieval. Alternatively the surface system 308 may store the raw data for future retrieval, or may communicate the raw data to a remote location for calculations to be performed elsewhere.

The location of each magnet 100 may be in terms of depth in relation to the surface, or in terms of a displacement from the initial conditions. Further calculations may allow the determination of any lateral displacement of each ring magnet 100.

The measurement of the magnetic field detectable by each probe 200 may be in response to the read command described above, or alternatively each probe 200 may measure the magnetic field continuously. The magnetic field detected by each probe 200 may be communicated to the surface system 308 by means of the single cable digital bus 306.

For greater accuracy of displacement determinations, it may be desirable to locate a large number of ring magnets in the soil 330, each at a certain initial separation, along with a large number of probes 200. In this way, the magnetic field cumulatively produced by the ring magnets 100 will have a periodic waveform, allowing a greater accuracy of calculation.

In an alternative arrangement, it may be desirable to have a greater number of probes 200 than ring magnets 100.

The present invention removes the need for a probe to be manually moved up and down a borehole such that the location of each ring magnet be detected. Instead, the present invention may not require any moving parts, and indeed no intervention by an operator after the initial set up. Furthermore, the displacement and deformation of the soil 330 may be communicated to a remote location, for example a location to which other similar systems relay their information, such that an operator need not revisit the construction site 300 until it is determined that, for example, sufficient consolidation has occurred and/or construction is due to begin.

### Installation

The following description is given to enable the installation of the present invention at a construction site.

A borehole 302 can be drilled at the construction site to a depth that allows its lowermost end to contact, but ideally penetrate, stable stratum 320.

Ring magnets 100 comprising projections 106, may be inserted into the borehole 302. The projections 106 may be trussed during installation such that they do not protrude beyond the sides of the ring magnet 100. When a ring magnet 100 is lowered to a chosen depth within the borehole 302, the trussing is released such that the projections 106 unfurl and engage the surrounding soil 330 or material 340. The ring magnet 100 is thus held at this location.

An access tube 316 may be installed into the borehole 302. The access tube 316 may be centred within the borehole 302, passing through the central opening 104 of each ring magnet 100. The access tube 316 may have an end cap which sits at the lowermost end of the borehole 302.

The space 314 between the wall of the borehole and the outside of the access tube 316 may be filled with a filler, such as bentonite grout, to support the weight of the ring magnets 100 whilst maintaining their ability to move freely with the consolidating soil 330, 340.

The depth of each ring magnet 100 may be checked or determined more accurately by means of a probe 200 attached to a measuring device. A number of probes 200 may be attached to a support 304 at locations corresponding to the depths of the ring magnets 100 which have already been installed. Alternatively, the probes 200 may be attached to the support 304 at fixed intervals. These probes 200 may be connected in series by means of a single cable digital bus 306. The support 304, including probes 200, is then lowered and installed in the borehole 302. For a vertical borehole 302 with a rigid support 304, the probes 200 are laterally attached onto the rigid support 304, and the rigid support 304 is bottom-supported within the access tube 316 by means of a support structure at its base 312.

The single cable digital bus 306 connecting the probes 200 may be connected to the surface system 308.

Initial conditions of the system may be measured and determined. The surface system 308 may be configured to automatically send read commands to the probes 200 according a timer, an event or a command from a user. Additionally, the surface system 308 may be configured to communicate initial and future measurements and/or determinations to a remote location. As such, after the initial installation, the system may automatically monitor the ground movement or consolidation of the site, and automatically communicate any data with a remote location.

It is noted that the present system may alternatively be installed at a pre-existing borehole 302, which may have previously been fitted with ring magnets 100 and an access tube 316, for example those suitable for other ground movement monitoring systems. The depth of each ring magnet 100 may be determined by lowering a probe 200 attached to a measuring device into the borehole 302. The probes 200 can then be fitted to the support so that, when they are installed in the borehole 302, they align with respective ring magnets 100. The support 304 and probes 200 can then be installed inside the access tube 316, and the installation process may proceed as normal. In this way, the present system can replace other ground movement monitoring systems in situ, by back-fitting to pre-existing boreholes 302, thus allowing the advantages of the present invention without incurring the additional cost and inconvenience of the installation of a new borehole 302, access tube 316 or ring magnets 100.

It will be appreciated by those skilled in the art that although the invention has been described by way of example, with reference to one or more exemplary examples, it is not limited to the disclosed examples and that alternative examples could be constructed without departing from the scope of the invention as defined by the appended claims.

1. A ground movement monitoring system comprising:
a rigid support;
a magnetically sensitive probe; and
a magnet,
wherein the probe is capable of detecting a displacement of the magnet,
wherein in use:
the magnet is configured to be fixed in the ground;
the support is configured to be located in the ground, an end of the support being fixed in position relative to the ground; and
the probe is configured to be attached to the support proximally to the magnet, wherein the displacement of the magnet as detected by the probe is communicated to a surface system, the surface system being configured to record any displacement of the magnet.

2. The system of claim 1, wherein the system additionally comprises:
at least one other magnetically sensitive probe; and
at least one other magnet.

3. The system of claim 2, wherein the probes are connected in series to the surface system by means of a single cable digital bus.

4. The system of claim 1, wherein the system is configured to be located within a borehole.

5. The system of claim 1, wherein the rigid support is fixed substantially vertically within the ground.

6. The system of claim 5, wherein the rigid support is bottom-supported.

7. The system of claim 1, wherein the at least one probe is rotationally invariant.

8. The system of claim 1, wherein the at least one magnet is a ring magnet.

9. The system of claim 1, wherein the at least one ring magnet is configured in use to be located peripherally to a borehole.

10. The system of claim 1, wherein the probes attach laterally to the support by means of a recess.

11. The system of claim 1, wherein each probe is attached to the support by means of:
a clearance fit between the recess and support; and
at least one releasable fixing.

12. The system of claim 1, wherein the probes are located centrally within the borehole with respect to vertical axis of the borehole.

13. The system of claim 1, wherein non-grooved access casing is used.

14. The system of claim 1, wherein the system is configured to determine displacements of the magnets.

15. The system of claim 1, wherein the system is configured to communicate the displacement of the ring magnets to a location remote from the system.

16. The system of claim 1, wherein the system is automated.

17. A method of preparing a site for construction, the method comprising:
surcharging the site with additional material;
installing the ground movement monitoring system of claim 1;
configuring the surface system to determine the displacement of each magnet; and
removing the additional material when it is determined that the site is normally consolidated.

18. A ground movement monitoring system comprising:
a rigid support which when installed in a borehole formed in the ground extends continuously from a bottom of the borehole to a mouth of the borehole;
a magnet provided in the ground adjacent the borehole; and
a magnetically sensitive probe attached to the support proximate the magnet and configured to detect a displacement of the magnet.

19. The system of claim 18 wherein the probe is attached in a direction approximately perpendicular to a longitudinal axis of the support.

20. The system of claim 18 wherein the support is provided off-centre with respect to a central axis of the borehole, such that the probe is centered with respect to the central axis of the borehole.
